(19) United States
(12) Patent Application Publication
(10) Pub. No.: US 2023/0157316 A1
(43) Pub. Date: May 25, 2023

(54) METHOD FOR MIXING CELL-BASED MEAT

(71) Applicant: Upside Foods, Inc., Berkeley, CA (US)

(72) Inventor: Morgan Laurence Rease, Emryville, CA (US)

(21) Appl. No.: 17/937,996

(22) Filed: Oct. 4, 2022

Related U.S. Application Data
(60) Provisional application No. 63/281,435, filed on Nov. 19, 2021.

(51) Int. Cl. A23J 3/22; A23J 3/04

(52) U.S. Cl. CPC A23J 3/227; A23J 3/04

(57) ABSTRACT

This disclosure relates to methods of size reducing, mixing, and folding subsets of a raw cell-based-meat product to improve the texture of a cell-based-meat product. The disclosed method can include collecting different portions of raw tissue product from either a single grown cell mass or different grown cell masses. The disclosed method can include finely chopping a first portion of cell mass into a fibrous pulp or paste and coarsely size-reducing a second portion of cell mass into segments. The first and second portions can be recombined and thoroughly mixed. In particular, the disclosed method includes mixing techniques that align fibers within the recombined portions. Examples of mixing techniques include dragging tines through the recombined portions, utilizing an extruder, and other methods. The combined mixture can further be flattened and folded to give the combined mixture additional structure and organization to better mimic conventional slaughtered meat.

### CROSS-REFERENCE TO RELATED APPLICATIONS

The present application claims the benefit of, and priority to, U.S. Provisional Application No. 63/281,435, entitled “METHOD OF MIXING CELL-BASED MEAT,” filed on Nov. 19, 2021. The aforementioned application is hereby incorporated by reference in its entirety.

### BACKGROUND

As the world's population continues to grow, cell-based or cultured meat products for consumption have emerged as an attractive alternative (or supplement) to slaughtered meat from animals. For instance, cell-based, cultivated, or cultured meat represents a technology that could address the specific dietary needs of humans. Because the cells for cell-based meat are lab grown, lab methods of preparing cell-based meat can modify the profile of essential amino acids and fats and enrich such meat in vitamins, minerals, and bioactive compounds. In some cases, cell-based-meat products can be prepared from a combination of cultivated adherent and suspension cells derived from a non-human animal that facilitate such modifications and enrichment.

In addition to addressing dietary needs, cell-based-meat products help alleviate several drawbacks linked to conventional meat products for humans, livestock, and the environment. For instance, conventional meat production involves controversial practices associated with animal husbandry and slaughter. Other drawbacks associated with conventional meat production include low conversion of caloric input to edible nutrients, microbial contamination of the product, emergence and propagation of veterinary and zoonotic diseases, relative natural resource requirements, and resultant industrial pollutants, such as greenhouse gas emissions and nitrogen waste streams.

Despite advances in creating cell-based-meat products, existing methods for cultivating and processing cell-based-meat products face several shortcomings, such as challenges or failures to mimic the textures and nutritional composition of slaughtered meat. In particular, existing methods often produce cell-based-meat products with undesirable texture and consistency. Indeed, some existing methods produce cell-based-meat products that are mushy and soft—unlike the texture and consistency of a slice, slab, or other cut of slaughtered meat. While such cell-based-meat products may better mimic ground meat products, such as burgers, with processing, existing methods fall short of creating cell-based-meat products with textures comparable to substantial cuts of conventional meat, like steaks or chicken breasts.

These, along with additional problems and issues exist in existing methods for cultivating cell-based-meat products.

### BRIEF SUMMARY

This disclosure generally describes methods of size reducing, mixing, and folding subsets of a raw cell-based-meat product to improve the texture of a cell-based-meat product. The disclosed method can include gathering raw tissue product and segmenting the raw product into a first portion and a second portion of cell-based meat. In some embodiments, the disclosed method further includes finely chopping the first portion into a fibrous pulp or paste and coarsely size-reducing the second portion into segments or pieces. The disclosed method can further include recombining the first and second portions and thoroughly mixing the portions. In particular, the disclosed method includes mixing methods that drag meat fibers within the separated or combined portions using tines, an extruder, or other techniques to better align the meat fibers. The combined mixture can further be flattened and/or folded to give the combined mixture additional structure. The disclosed method can include several cycles of repeatedly flattening and folding to create folded layers of cell-based meat with aligned meat fibers.

After one or both of flattening and folding, the method produces a cell-based-meat product with a texture and structure more like slaughtered meat than existing methods. When the meat fibers are aligned according to the disclosed technique, the texture of the mixed cell-based-meat product mimics the natural texture of conventional meat products better than unprocessed or preprocessed adherent cell cultures or unprocessed or preprocessed suspension cell culture. By chopping, mixing, flattening, and folding a cell-based-meat product, the disclosed techniques align meat fibers and produce a highly ordered fiber and layered structure that can better mimic the structure and fibers of conventional meat cuts. Additional features and advantages of one or more embodiments of the present disclosure will be set forth in the description that follows.

### BRIEF DESCRIPTION OF THE DRAWINGS

Various embodiments will be described and explained with additional specificity and detail through the use of the accompanying drawings, which are summarized below.

FIGS. 1A-1B illustrate an overview diagram of creating a textured product having aligned meat fibers in accordance with one or more embodiments of the present disclosure.

FIG. 2 illustrates pulverizing or otherwise cutting a first portion into a fibrous substance in accordance with one or more embodiments of the present disclosure.

FIG. 3 illustrates size reducing a second portion into segments in accordance with one or more embodiments of the present disclosure.

FIG. 4 illustrates utilizing various instruments to align meat fibers in a fibrous substance and segments in accordance with one or more embodiments of the present disclosure.

FIGS. 5A-5B illustrate flattening a combined mixture and folding the flattened combined mixture in accordance with one or more embodiments of the present disclosure.

FIGS. 6A-6B illustrate an example textured product having aligned meat fibers in comparison with an untextured product in accordance with one or more embodiments of the present disclosure.

FIG. 7 illustrates a series of acts for creating a textured meat product in accordance with one or more embodiments of the present disclosure.

### DETAILED DESCRIPTION

This disclosure describes one or more embodiments of a method for creating a textured grown cell mass having a texture more similar to slaughtered meat. In one or more embodiments, the disclosed method includes collecting different portions of raw tissue product. The disclosed method includes processing the first portion until it resembles a fibrous pulp or paste to break down long fibrous materials within the first portion. The second portion is processed by size reducing the raw tissue product to maintain some long fibers. In some cases, both the first and second portions of cell mass are mixed and drawn to align internal meat fibers using tines, an extruder, or other aligning techniques.

After size reducing and optional mixing of the different portions of cell mass, the disclosed method can include recombining the first portion and the second portion in a recombined mixture. In some embodiments, the disclosed method further includes utilizing mixing methods that align fibers within the recombined portions. The recombined mixture can be flattened and folded over itself to further align fibers and provide additional structure. Indeed, in some embodiments, the recombined mixture is repeatedly flattened and folded to create outer and inner layers with aligned meat fibers that mimic the structure of a cut of slaughtered meat.

By portioning, mixing, flattening, and folding recombined tissue of cell-based meat, the disclosed method results in a textured cell-based-meat product having a higher order structure. In particular, the flattening and folding results in a textured product comprising layers of a grown cell mixture having fibers aligned in different directions. For example, a textured product can include a first layer of a grown cell mixture having fibers aligned in one direction, a second layer of the grown cell mixture having fibers aligned in another direction, and any number of additional layers having fibers aligned in yet different directions. Thus, the resulting textured product can have fibers that are aligned in various configurations, such as loops and switchbacks that traverse x, y, and z axes.

As suggested above, in one or more embodiments, the disclosed method includes collecting at least a first portion of cell mass and a second portion of cell mass. Generally, the disclosed method includes utilizing different size reduction techniques on each portion to enhance cohesion of a combined mixture while maintaining fiber length for alignment in future steps. In particular, the disclosed method includes pulverizing or cutting the first portion into a fibrous substance, such as a fibrous pulp or a fibrous paste. In some embodiments, the disclosed method includes finely chopping the first portion to break down long fibrous materials and results in fine pieces having small fibers. The fibrous substance aids in cohesion of the combined mixture.

In addition to finely size reducing the first portion of cell mass, the disclosed method further includes coarsely size reducing the second portion of cell mass into segments. Generally, the segments of the second portion are larger than the fine pieces within the fibrous substance of the first portion. For instance, the disclosed method can include roughly chopping or tearing the second portion to create segments that maintain long fibers. As described below, the fibers within the segments of the second portion can be aligned during the size reducing or in later steps.

After size reducing both the first portion and the second portion of cell mass, the disclosed method can further include combining the fibrous substance from the first portion and the segments from the second portion to create a combined mixture. The combined mixture can include longer fibers from segments of the second portion held together by the fibrous substance of the first portion. In some embodiments, the disclosed method includes various mixing techniques to align the fibers within the combined mixture. For example, the fibers can be aligned by pushing or pulling tines through the combined mixture, forcing the combined mixture through an extruder, or other methods. As mentioned, aligning fibers within the combined mixture provides additional structure within a textured product.

In addition to aligning fibers at a primary level, the disclosed method creates textured product with a more organized tertiary structure. In particular, the disclosed method can include further structuring the combined mixture by flattening and folding the combined mixture. For example, in some embodiments, the disclosed method includes performing cycles of flattening and folding the combined mixture to create a textured product having layers of combined mixture with aligned fibers.

The disclosed method provides several benefits relative to unprocessed adherent cell cultures or other existing and unprocessed cell-based meats. In particular, the disclosed method utilizes various mixing, flattening, and folding methods to align and provide secondary structure for fibers within a grown cell mass. In particular, slaughtered meat typically comprises muscle fibers that are aligned. The disclosed method creates textured cell-based-meat product having aligned fibers by utilizing mixing methods to align fibers within the combined mixture. For example, the disclosed method can include dragging tines through a combined mixture to align fibers. In contrast to unprocessed or raw cell-based-meat products with randomly oriented fibers, the disclosed method creates textured product with fibers that mimic the alignment found in slaughtered meat, such as cuts of butchered meats.

In addition to mimicking the fiber alignment in slaughtered meat, the disclosed method improves the texture of cell-based-meat product by creating a more organized tertiary structure. In particular, the disclosed method includes flattening and folding steps that creates layers of aligned meat fibers. For example, the muscle fibers found in slaughtered meat are typically stacked or otherwise arranged in a lengthwise fashion. Similarly, the textured product created by the disclosed method includes layers of aligned fibers that are stacked on each other. Accordingly, the disclosed method aids in solving the problem of undesirable textures in unprocessed adherent cell cultures or other existing and unprocessed cell-based meats.

As illustrated by the foregoing discussion, the present disclosure utilizes a variety of terms to describe features and advantages of the disclosed method. Additional detail is now provided regarding the meaning of such terms. For example, as used herein, the term “grown cell mass” or simply “cell mass” refers to a mass comprising grown cells of meat. In particular, a grown cell mass refers to cells of cultured meat gathered into a collective mass. As discussed below, a grown cell mass may comprise different cell types, such as one or more of myoblasts, mesangioblasts, myofibroblasts, mesenchymal stem cells, hepatocytes, fibroblasts, pericytes, adipocytes, epithelial, chondrocytes, osteoblasts, osteoclasts, pluripotent cells, somatic stem cells, endothelial cells, and other similar cell types. For example, a grown cell mass can include a grown cell sheet of cultured meat grown within an enclosure, such as a chamber, housing, container, etc.

As used herein, the term “cell-based-meat product” refers to a meat product made of animal cells. In particular, a cell-based-meat product includes a meat produced by in vitro cell culture of animal cells. For example, a cell-based-meat product can be a combination of animal muscle or fat cells grown within a bioreactor. Furthermore, a cell-based meat product can include cultivated meat or cultured meat.

As used herein, the term “portion” refers to an amount of cell mass or a part of a cell mass. In particular, a portion refers to a part of a grown cell mass or different grown cell masses of different amounts. For example, a portion can include a fraction or percentage of a grown cell mass. For instance, one portion may comprise one quarter to one half of a grown cell mass, and another portion may comprise one half to three-quarters to one half of the grown cell mass. To illustrate, in certain cases, a first portion comprises one third of a grown cell mass, and a second portion comprises two thirds of the grown cell mass. Accordingly, portions of a grown cell mass can be separated from each other. In another example, a first portion includes a first grown cell mass and a second portion includes a second grown cell mass. For instance, a first portion can include a first grown cell mass comprising myocytes and a second portion can include a second grown cell mass comprising adipocytes or other type of cell. As described herein, however, a first portion and a second portion can include any of the cell types described in this specification.

As used herein, the term “size reducing” refers to a process of reducing a large solid unit mass into smaller unit masses. In particular, size reducing can refer to reducing a grown cell mass or a portion of a grown cell mass into segments or small segments. For example, size reducing may be accomplished by rough cutting, chopping, tearing, pulverizing, or otherwise separating a portion of a grown cell mass into segments. In some cases, one portion may be finely size reduced into a fibrous pulp or paste, and another portion may be coarsely size reduced into irregular segments of a threshold length.

As used herein, the term “fibrous substance” refers to a group or mass of grown cells chopped or otherwise cut into fine pieces that include meat fibers. In particular, a fibrous substance includes a group of grown cells finely chopped, diced, pulverized, or otherwise cut into fine pieces. For example, a fibrous substance can include a fibrous pulp or a fibrous paste with meat fibers that give the pulp or paste a fibrous texture.

As used herein, the term “segments” refers to irregular or rectangular parts of a grown cell mass. In particular, segments include grown cells with long fibers. More specifically, segments include fibers that are longer than fibers found in a fibrous substance. For example, segments can refer to a grown cell mass that has been coarsely size reduced. In some examples, segments include a grown cell mass that has been coarsely chopped into portions having a given length and width. Relatedly, as used herein, the term “small segments” refers to parts within the segments. As used herein, the term “fine pieces” refers to parts within a fibrous substance. In particular, fine pieces include grown cells with short fibers. Fine pieces are smaller than small segments.

As used herein, the term “combined mixture” refers to a cell grown mass having two different portions mixed or otherwise combined together. In particular, a combined mixture can include a smaller portion of grown meat cells and a larger portion of grown meat cells mixed together. For example, in some embodiments, a combined mixture includes both a first portion comprising a fibrous substance and a second portion comprising segments mixed together. In some embodiments, fibers within the combined mixture are aligned.

As used herein, the term “textured product” refers to a textured grown cell mass of meat. In particular, fibers within a textured product are more aligned than are fibers within a grown cell mass. For example, a textured product can include fibers that are roughly aligned and layered to better mimic the texture of slaughtered meat.

As used herein, the term “layer” refers to a section or sheet of a grown cell mixture within a textured cell-based-meat product. For example, a layer can comprise a section or sheet of a grown cell mixture having fibers aligned in a given position positioned over or under another layer of the grown cell mixture having fibers aligned in a different position.

As used herein, the term “meat fiber” refers to a group of animal cells organized in a fibril structure, such as a thread or filament of meat. For example, a grown cell mass can include meat fibers with different orientations. Meat fibers can comprise various types of animal cells including connective tissue and muscle tissue.

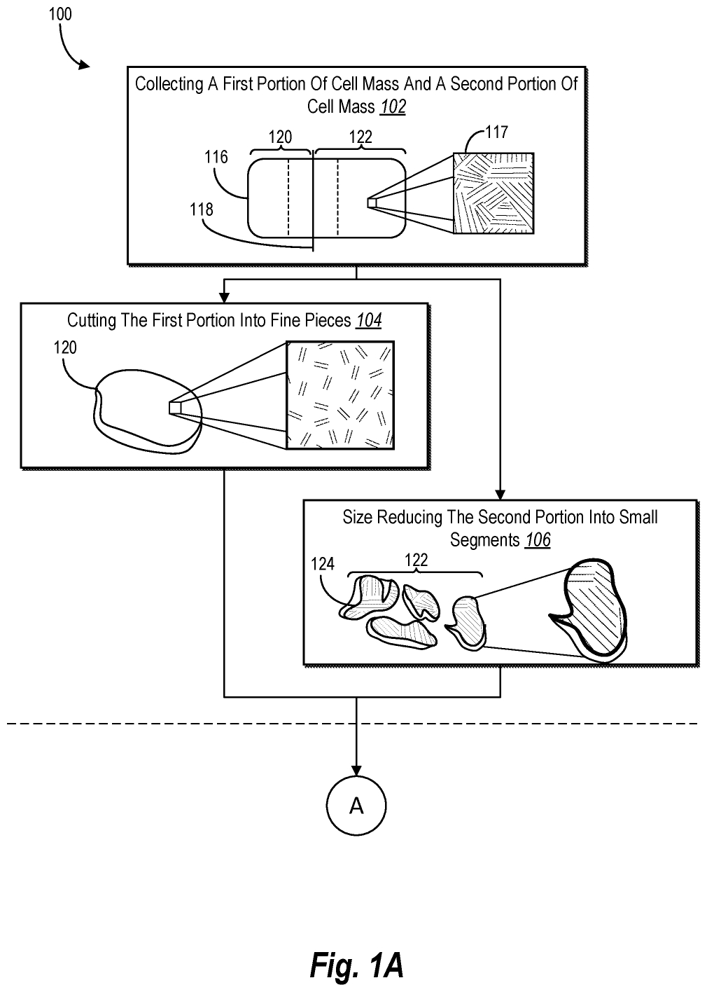

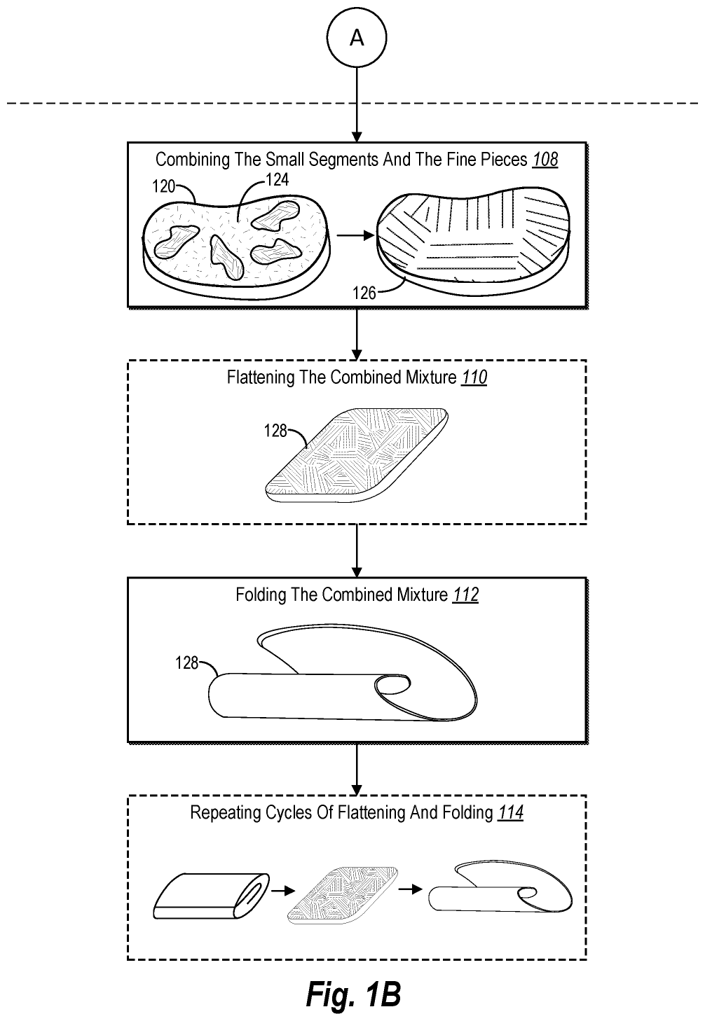

Additional detail will now be provided regarding a disclosed method in relation to illustrative figures portraying example embodiments and implementations of the disclosed method. For example, FIGS. 1A-1B illustrate a series of acts 100 for forming a textured product. FIGS. 1A-1B illustrate acts in the disclosed method directed toward combining fine pieces from a first portion and small segments from a second portion into a combined mixture, aligning fibers within the combined mixture, flattening, and folding the combined mixture to create a more complex structure for a final textured product. In particular, the series of acts 100 includes an act 102 of collecting a first portion of cell mass and a second portion of cell mass, an act 104 of cutting the first portion into fine pieces, an act 106 of size reducing the second portion into segments that exceed a size of the fine pieces, an act 108 of combining the small segments and the fine pieces, an act 110 of flattening the combined mixture, an act 112 of folding the combined mixture, and an optional act 114 of repeating cycles of flattening and folding.

As illustrated in FIG. 1A, the series of acts 100 includes the act 102 of collecting a first portion of cell mass and a second portion of cell mass. As mentioned previously, the disclosed method includes gathering a grown cell mass 116. The grown cell mass 116 comprises grown cells that are part of cultivated meat. For example, the grown cell mass 116 can comprise raw tissue product created using a bioreactor. The grown cell mass 116 can be integral tissue, which may comprise a cohesive sheet of tissue, such as tissue produced by an adherent cell culture.

As illustrated, the grown cell mass 116 includes fibers 117 that are randomly organized or structured prior to processing. The fibers 117 represent structure of meat cells within the grown cell mass 116. For example, the fibers 117 can comprise groups of muscle cells organized in fibril structure.

In some embodiments, the disclosed method includes further processing the grown cell mass 116. In particular, tissues within the grown cell mass 116 must often be processed to bring the protein and solid content within an acceptable range for consumption. The disclosed method can further include combining one or more additives with the grown cell mass 116. For example, additives may include pea protein, salt, flavoring, coloring, oils, and other compounds. In some embodiments, the inclusion of such additives in a particular order further enhances the fiber alignment or tertiary structure of the final textured product. For example, additives may be mixed into the grown cell mass, the first portion, the second portion, and/or the combined mixture.

In some embodiments, the act 102 of collecting a first portion of cell mass and a second portion of cell mass comprises separating a grown cell mass into portions by making a cut 118 to divide the grown cell mass 116 into portions. In particular, the grown cell mass 116 is separated into a first portion 120 and a second portion 122. FIG. 1A illustrates the first portion 120 having a mass of about one third of the grown cell mass 116 and the second portion 122 having a mass of two thirds of the grown cell mass 116. But the first portion 120 and the second portion 122 can make up different proportions of the grown cell mass 116. For example, the first portion 120 can be made up of one quarter to one half of the grown cell mass 116. The second portion 122 can be made up of one half to three-quarters of the grown cell mass 116. In yet other embodiments, the first portion 120 and the second portion 122 comprise different proportions of the grown cell mass 116.

Additionally, or alternatively, the act 102 comprises utilizing one or more grown cell masses as the first portion and the second portion. In particular, the disclosed method can include collecting a first grown cell mass as the first portion of cell mass and a second grown cell mass as the second portion of cell mass. In another example, the act 102 comprises collecting one or more cell masses as the first portion and one or more cell masses as the second portion. Furthermore, each of the individual cell masses can comprise different cell types. For instance, a first cell mass can include myocytes, a second cell mass can include adipocytes, and a third cell mass can include fibrocytes.

In some embodiments, the proportions of each portion can be adjusted according to the texture of the combined mixture. A lower proportion of the fibrous substance of the first portion 120 may result in a combined mixture being too coarse and lacking cohesion while a higher proportion of the first portion 120 may result in a combined mixture that is too soft.

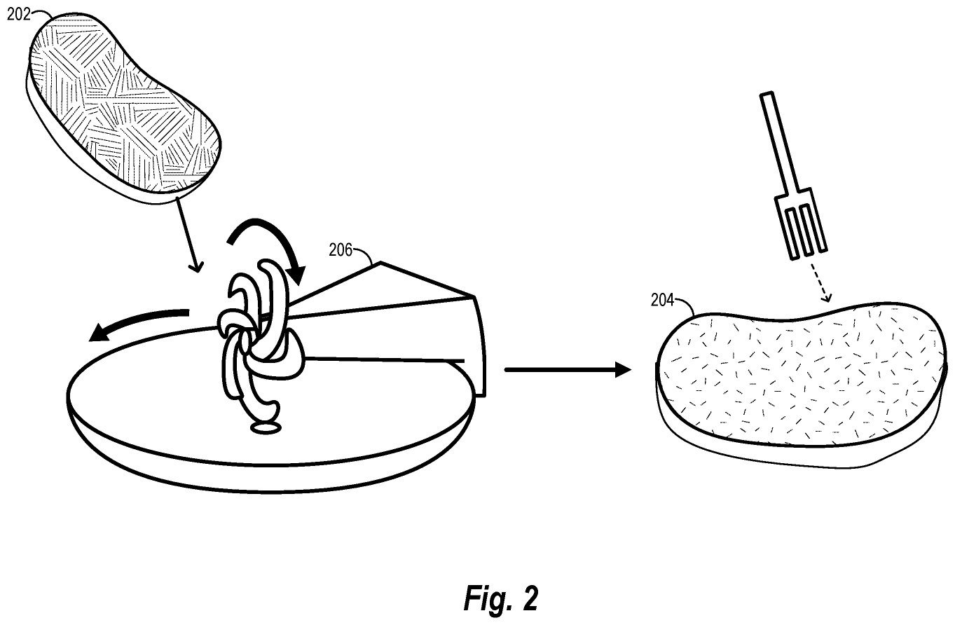

As further illustrated in FIG. 1A, the series of acts 100 includes the act 104 of cutting the first portion into fine pieces. In particular, as part of the act 104, the first portion 120 is finely chopped until the first portion 120 becomes a fibrous substance. The fibrous substance resembles a fibrous pulp or paste and is made up of fine pieces. In some embodiments, the act 104 comprises size reducing the first portion 120 by chopping, dicing, cutting, or pulverizing the grown cells that are part of the first portion 120. As a result of performing the act 104, at least a portion of long fibers are broken down into shorter and more compact fibers. In some embodiments, the act 104 further includes mixing the fine pieces with each other (e.g., using tines or an extruder) while aligning meat fibers within the first portion. FIG. 2 and the corresponding paragraphs provide various examples of how the act 104 can be performed in accordance with one or more embodiments.

FIG. 1A also illustrates the act 106 as part of the series of acts 100. In particular, the act 106 comprises size reducing the second portion into small segments. Generally, the act 106 coarsely size reduces the second portion 122 into small segments 124 that are larger than the fine pieces. In particular, the act 106 maintains a substantial portion of long fibers that can be aligned in later steps to improve the texture of the final textured product. In some embodiments, the act 106 comprises tearing apart the second portion 122 into irregularly sized small segments.

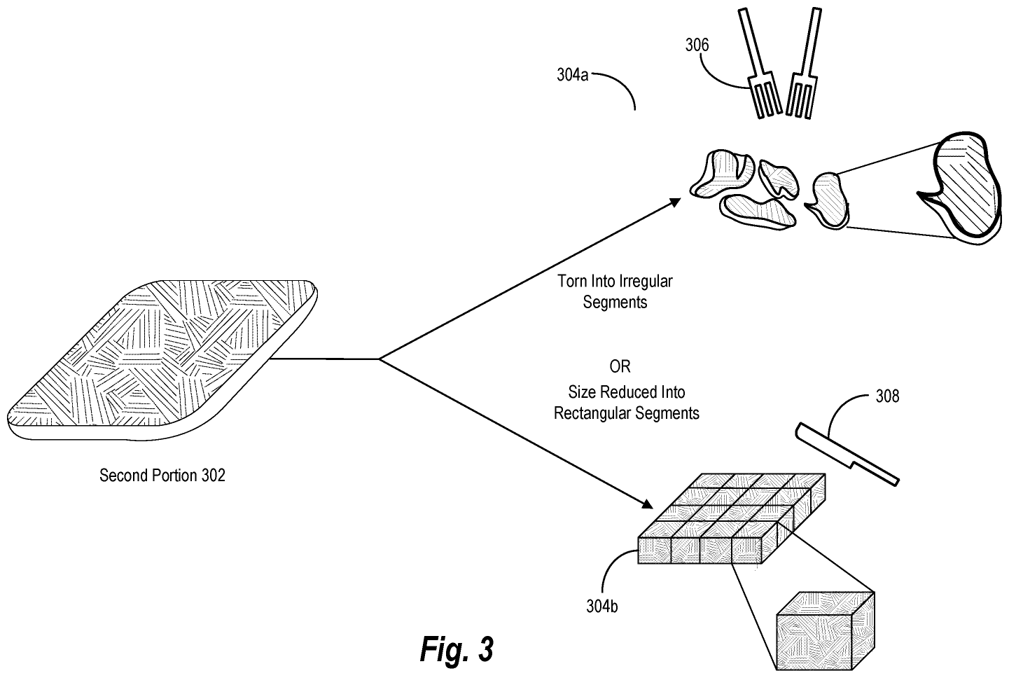

In some embodiments, the act 106 is performed by coarsely chopping or cutting the second portion 122 into squares or rectangles having a threshold length. In one or more embodiments, the small segments 124 are rectangular cuboids having an approximate length, width, and height. For example, in at least one embodiment, the length of the small segments 124 equals 9 cm, the width equals 3 cm, and the height equals ½ cm. In some embodiments, the act 106 includes mixing the small segments 124 with each other e.g., using tines or an extruder) while aligning meat fibers within the second portion. FIG. 3 and the corresponding paragraphs provide examples of how the act 106 is performed in accordance with one or more embodiments.

As illustrated in FIG. 1B, the series of acts 100 includes the act 108 of combining the small segments and the fine pieces. As illustrated, the act 108 includes combining fine pieces from the first portion 120 and the small segments 124 from the second portion. As illustrated, the fine pieces of the first portion 120 include shorter fibers while the small segments 124 include longer fibers. The small segments 124 and the fine pieces are combined and then mixed to create a combined mixture 126. In particular, the act 108 can include mixing techniques that align fibers within the fine pieces and the small segments 124.

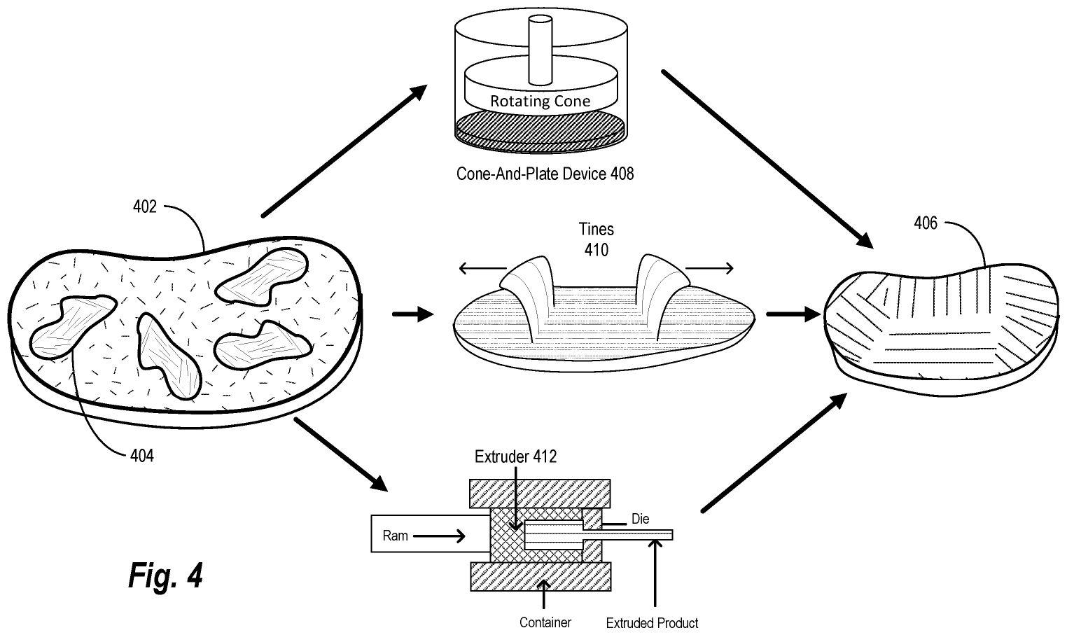

In contrast to general mixing techniques that result in fibers that are randomly oriented, the mixing techniques utilized as part of the act 108 facilitate fiber alignment. As illustrated in FIG. 1B, the fibers within the combined mixture 126 are more aligned and organized relative to fibers in the grown cell mass 116. FIG. 4 and the accompanying paragraphs illustrate example mixing methods for fiber alignment in accordance with one or more embodiments.

After the act 108, in some embodiments, the disclosed method includes an additional act of portioning the combined mixture 126. In particular, the additional act can include portioning the combined mixture into final product weights before performing the act 110 of flattening the combined mixture. Generally, the combined mixture 126 is divided into final product portions having final product weights. The final product weights reflect desired weights for the final product, such as meat patties, fillets, nuggets, etc. For example, in some products, the final product weight is less than 1 oz. In some products, the final product weight is 2-4 oz, and in yet other products, the final product weight is 4-8 oz. In some embodiments, the final product portions are further shaped to a desired shape.

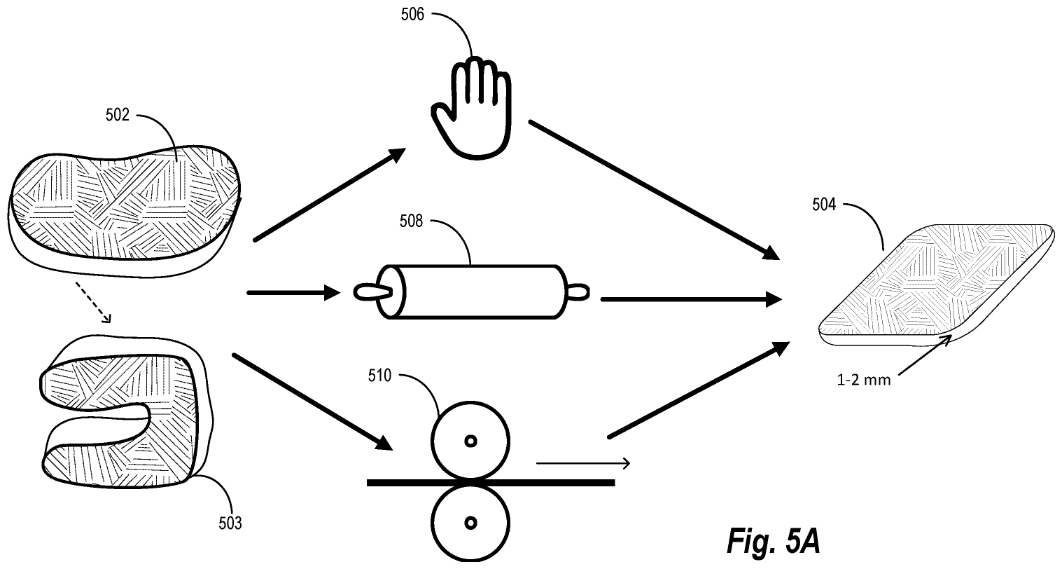

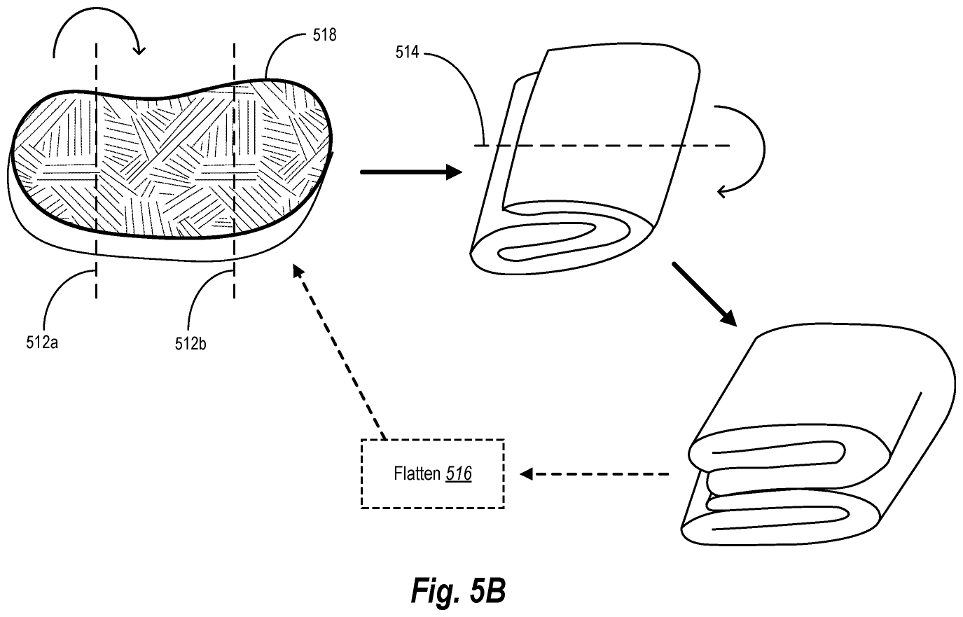

After combining the small segments and the fine pieces and optionally portioning into final weight products, the series of acts 100 illustrated in FIG. 1B further includes the act 110 of flattening the combined mixture. Generally, the combined mixture 126 is flattened to form a flattened combined mixture 128. The act 110 further aligns fibers within the combined mixture. In some embodiments, the combined mixture is flattened to a threshold height. For example, the flattened combined mixture 128 can have a height of 1-2 mm. In other embodiments, the flattened combined mixture 128 is thicker or thinner than 1-2 mm. FIG. 5A and the corresponding paragraphs provide example methods by which the combined mixture can be flattened in accordance with one or more embodiments.

In some embodiments, the act 110 of flattening the combined mixture is an optional act. In one example, the combined mixture is flattened as part of performing the act 108 of combining the small segments and the fine pieces. To illustrate, if the act 108 is performed by advancing the small segments and the fine pieces through an extruder, the combined mixture will be in a flattened form. Thus, in some cases, the method may proceed from the act 108 of combining the small segments and the fine pieces directly to the act 112 of folding the combined mixture.

As further illustrated in FIG. 1B, the series of acts 100 includes the act 112 of folding the combined mixture. In some embodiments, the act 112 includes folding the flattened combined mixture 128 onto or within itself. The act 112 can include a number of fold configurations. For example, and as illustrated, the flattened combined mixture 128 can be folded into thirds. In another example, the flattened combined mixture 128 is folded over itself in half then folded in half in another direction. In some embodiments, the act 112 includes layering additional sheets of combined mixture on top of the combined mixture in addition to or instead of folding the combined mixture onto itself.

The series of acts 100 illustrated in FIG. 1B further includes the optional act 114 of repeating cycles of flattening and folding. In particular, the optional act 114 can further comprise performing a plurality of cycles of flattening the combined mixture and folding the flattened combined mixture. Generally, repeating the cycles of flattening and folding further aligns fibers within the combined mixture and consequently improves the texture of the final product. For example, the flattening and folding process may be repeated three times, ten times, etc.

In some embodiments, the disclosed method creates structural filaments as part of the series of acts 100. A structural filament may be a structure on the outer layer or within a portion of cell mass that takes the form of a filament, such as an inner fold or edge of the grown cell mass 116 or the combined mixture 126 created by folding or flattening. To illustrate, structural filaments can be formed by performing the acts 110 and 112 of flattening and folding the cell mass. Additionally, or alternatively, structural filaments can be created by rolling, wrinkling, tearing, or otherwise manipulating the grown cell mass 116 or the combined mixture 126. Generally, structural filaments improve the texture of a cell-based meat by mimicking layers of fibers found in slaughtered meat.

Additionally, as part of the series of acts 100 in some embodiments, the combined mixture is formed into a final textured product. For example, the combined mixture can be formed to the shape of a nugget, fillet/tender, a disc/patty, a rectangle, a square, a cylinder, or any desired 3D shape of a final meat product. In some embodiments, the combined mixture is formed into the final textured product using a mold. In other embodiments, the combined mixture is cut into the final textured product. In yet other embodiments, the combined mixture is formed into the final textured product by folding the combined mixture into the desired shape. Additionally, in one or more embodiments, enzymes or other binders are added as part of the forming step to help bind proteins together during molding or final folding. Enzymes may be used to cross-link the proteins within the final textured product. Other binders can include gelatin, fat, egg, protein, flour, starch, or other ingredients.

FIGS. 1A-1B illustrate a general overview of aligning fibers within a textured product. The following figures and corresponding discussion provide additional detail regarding the acts illustrated in FIGS. 1A-1B. For example, FIG. 2 illustrates an example method for pulverizing a first portion into a fibrous substance. As mentioned previously, the first portion can be made up of one quarter to one half of the grown cell mass. In particular, FIG. 2 illustrates pulverizing a first portion 202 of a grown cell mass into a fibrous substance 204 by utilizing a bowl chopper 206. As illustrated in FIG. 2, through the process of pulverizing, long fibers within the first portion 202 are shortened into shorter fibers within the fibrous substance 204.

Generally, the first portion 202 is finely chopped, pulverized, or otherwise cut to shorten fibers within the first portion 202. In some embodiments, for instance, pulverizing the first portion 202 into the fibrous substance 204 comprises finely chopping the first portion into a fibrous pulp or a fibrous paste. After being finely chopped, the tissue within the fibrous substance 204 is made up of fine pieces that are compact. As a result of the tissues within the first portion 202 being finely chopped, the fine, fibrous pieces enhance binding qualities of the first portion 202 when combined with the second portion.

In some embodiments, the act of pulverizing the 202 is performed by finely chopping, dicing, or cutting the first portion 202 using blades of knives. In some embodiments, and as illustrated, the disclosed method includes the utilization of industrial scale equipment. In particular, FIG. 2 portrays pulverizing the first portion 202 utilizing a bowl chopper 206. In other embodiments, the first portion 202 is pulverized using pulverizer machines, vertical cutter mixers, meat grinders, and other equipment used for finely chopping, dicing, or cutting.

In some embodiments, the disclosed method further includes mixing the pulp or paste from the first portion. In particular, in some embodiments, the disclosed method includes mixing the fine pieces with each other. This optional mixing step aligns fibers within the pulp or paste from the first portion. For example, in some embodiments, this additional mixing step comprises aligning fibers by utilizing the tines of forks, an extruder, or any other mixing technique described below with respect to FIG. 4. In some embodiments, the fine pieces are mixed with each other simply to combine the fine pieces. For example, the fine pieces can be mixed using a spatula, mixer, or other mixing tool.

FIG. 2 and the corresponding discussion describe how the first portion may be pulverized into a fibrous substance made of fine pieces in accordance with one or more embodiments. FIG. 3 illustrates how the second portion can be size reduced into small segments that exceed a size of the fine pieces in accordance with one or more embodiments. As mentioned previously, the second portion can be one half to three-quarters of the grown cell mass. FIG. 3 illustrates size reducing a second portion 302 into small segments 304a-304b. As illustrated, the second portion 302 can be size reduced using forks 306, a knife 308, or other equipment.

Generally, as part of the step of coarsely size reducing, the second portion 302 is roughly chopped or otherwise size reduced to maintain some long fibers that may be aligned in later steps to improve the texture of the final textured product. The small segments 304a-304b exceed a size of the fine pieces from the first portion. The proportion of the small segments 304a-304b within the combined mixture impacts the softness of the final texturized product. For example, a higher proportion of the small segments 304a-304b can result in a final texturized product that is firmer than a final texturized product having a lower proportion of the small segments 304a-304b.

In some embodiments, size reducing the second portion 302 involves pulling or tearing the second portion 302 into the small segments 304a. For example, and as illustrated in FIG. 3, the second portion 302 can be size reduced by tearing the second portion 302 using the forks 306. For example, the forks 306 can be used to apply force to the second portion 302 in opposite directions, resulting in irregular sized versions of the small segments 304a. While the forks 306 may be used in some embodiments, the second portion 302 may also be torn into irregular sized small segments by hand. Alternatively, a mixer or other equipment may also be used to tear the second portion 302 into the small segments 304a.

Rather than tearing the second portion 302 into irregular, small segments, in some cases, the second portion 302 is cut into small segments. Generally, the second portion can be rolled out or flattened to an approximate height (e.g., ½ cm, 1 cm, etc.) and cut into small segments. For example, and as illustrated in FIG. 3, the second portion 302 is coarsely size reduced by cutting the second portion 302 using a knife 308.

As mentioned previously, in some embodiments, size reducing the second portion 302 comprises cutting the second portion 302 into pieces having a threshold length. The small segment 304b can have a predetermined threshold length (e.g., 3 cm, 4 cm, 2 in.). Furthermore, in some embodiments, the second portion 302 is cut in a way so the small segment 304b is a rectangular cuboid having an approximate length, width, and height. For example, the second portion 302 can be (i) rolled out or flattened to the approximate height (e.g., ½ cm, 1 cm, etc.) and (ii) cut into rectangular cuboids having approximate widths (e.g., 2 cm, 3 cm, etc.) and approximate lengths (e.g., 6 cm, 7 cm, 9 cm, etc.). In one or more embodiments, the second portion 302 is cut into cubes having an equal approximate length, width, and height.

Additionally, the second portion 302 can be coarsely size reduced to yield more irregularly shaped segments. In particular, the second portion 302 can be coarsely size reduced using random cuts with the knife 308. For example, the second portion 302 can be cut using rough and extremely coarse cuts to result in small segments having various 3D shapes that are not necessarily cubes or rectangular cuboids.

Additionally, in some embodiments, the disclosed method includes an optional act of mixing the small segments from the second portion with each other. In particular, the disclosed method can include utilizing a mixing technique to align fibers within the second portion. For example, the disclosed method can include utilizing a mixing technique, such as using tines or any of the mixing techniques described below in relation to FIG. 4. In some embodiments, the small segments are mixed with each other simply to combine the small segments. For example, the small segments can be mixed with each other using a spatula, mixer, or other mixing tool.

FIG. 3 and the corresponding discussion describe how the second portion can be coarsely size reduced in accordance with one or more embodiments. As discussed previously, the disclosed method further includes combining the fibrous substance from the first portion and the segments from the second portion to create a combined mixture. FIG. 4 and the corresponding discussion detail forming the combined mixture in accordance with one or more embodiments. In particular, FIG. 4 illustrates combining a fibrous substance 402 from the first portion with segments 404 from the second portion. FIG. 4 further illustrates the utilization of various mixing methods including a cone-and-plate device 408, tines 410, and an extruder 412 as options to mix the segments 404 and the fibrous substance 402 to create a combined mixture 406. The fibers in the combined mixture 406 are aligned using the mixing methods described below.

FIG. 4 illustrates various mixing techniques and instruments used to align meat fibers within the fibrous substance 402 and the segments 404. In particular, FIG. 4 illustrates the cone-and-plate device 408. The cone-and-plate device 408 aligns meat fibers by applying shearing force to the fibrous substance 402 and the segments 404. The fibrous substance 402 and the segments 404 are placed on a horizontal plate and a shallow cone placed into the mixture. The plate and/or cone can be rotated to apply shearing force to the fibrous substance 402 and the segments 404. The shearing force aligns the fibers within the mixture to yield the combined mixture 406 having aligned meat fibers.

As an alternative or an addition to mixing with the cone-and-plate device 408 and the extruder 412, FIG. 4 illustrates utilizing the tines 410 to align meat fibers within the fibrous substance 402 and the segments 404. Generally, the tines 410 can be pushed or pulled through the fibrous substance 402 and the segments 404 to align the meat fibers. For example, and as illustrated, the tines 410 are pulled in opposite directions through the fibrous substance 402 and the segments 404, and the resulting shearing forces and friction result in alignment of meat fibers within the combined mixture 406.

As an alternative or an addition to mixing with the cone-and-plate device 408 and the tines 410, FIG. 4 also illustrates utilizing the extruder 412 to align meat fibers within the fibrous substance 402 and the segments 404. In particular, the fibrous substance 402 and the segments 404 can be advanced through a die of the extruder 412. The meat fibers are aligned by laminar flow because of being forced through the die. Thus, the extruder 412 is another instrument that can align meat fibers for the combined mixture 406.

FIG. 4 depicts various instruments that may be utilized to align meat fibers through various mixing techniques. Meat fibers within a combined mixture may be further aligned or organized by flattening and folding the combined mixture. FIGS. 5A-5B illustrate various methods by which the combined mixture is flattened or folded in accordance with one or more embodiments. In particular, FIG. 5A illustrates various methods by which the combined mixture is flattened in accordance with one or more embodiments. FIG. 5B illustrates one method by which the combined mixture is folded in accordance with one or more embodiments.

FIG. 5A illustrates a combined mixture 502 having aligned meat fibers. The combined mixture 502 can be flattened by hand 506, rolling pin 508, or by an automated mechanism 510 (e.g., an industrial dough sheeter) to produce a flattened combined mixture 504. As illustrated in FIG. 5A, the combined mixture 502 can be flattened to an approximate width. For example, the flattened combined mixture 504 has an approximate width of 1-2 mm.

As further illustrated in FIG. 5A, in some embodiments, the disclosed method includes flattening a folded combined mixture 503. In particular, the folded combined mixture 503 represents a combined mixture that has been folded. In some embodiments, the folded combined mixture 503 represents a mixture that has been combined and simply folded. In other embodiments, the folded combined mixture 503 represents a combined mixture that has previously undergone flattening and folding.

In addition to and at times before flattening, in some embodiments, the disclosed method includes folding. FIG. 5B illustrates an example folding technique in accordance with one or more embodiments. As illustrated in FIG. 5B, the disclosed method includes folding a combined mixture 518 along vertical axes 512a-512b then folding the combined mixture 518 along a horizontal axis 514. In some embodiments, the disclosed method includes additional flattening steps after each fold or a series of folds. For example, the disclosed method can include an additional flattening step after folding the combined mixture 518 along one or both of the vertical axes 512a-512b.

As further illustrated in FIG. 5B, the disclosed method can include an optional act 516 of flattening the folded flattened combined mixture. For example, in some embodiments, the disclosed method includes performing a plurality of cycles of flattening and folding the combined mixture. Additionally, in some embodiments, a plurality of cycles of flattening and folding are performed to give added structure and further align the meat fibers within the combined mixture. For instance, in some cases, the disclosed method includes folding and flattening a combined mixture in five to ten cycles of the folding and flattening depicted in FIG. 5B.

FIG. 5B illustrates a single folding technique utilized in accordance with one or more embodiments. For example, the combined mixture 518 can be folded in half, quarters, etc. Additionally, the combined mixture 518 can be rotated and refolded in a variety of combinations. For example, the combined mixture 518 can be folded in half along a vertical axis and then folded into quarters along both horizontal and vertical axes.

In addition or in the alternative to folding, in some embodiments, the disclosed method includes stacking portions of cell mass or stacking a combined mixture. In particular, the disclosed method can include stacking layers of a combined mixture. For example, the disclosed method includes cutting the combined mixture 518 into sections and stacking the sections on top of each other. In some cases, such cutting and stacking of different portions of cell mass or of a combined mixture—followed by compression—resembles the operations of a Baker's map from dynamical systems theory. Stacking may be preferable to folding in instances where layers should have fibers aligned in the same direction. In another example, instead of (or in addition) to stacking layers of the same combined mixture, the disclosed method includes stacking different whole flattened combined mixtures.

In one or more embodiments, the flattening and folding steps are optional and may be omitted. In particular, the combined mixture may be portioned and formed into a final textured product after mixing. In one example, after forcing the fibrous substance and the segments through an extruder, the resulting combined mixture is cut, molded, or otherwise portioned into the final textured product. In some embodiments, the disclosed method may omit one of the flattening or folding steps. For example, the disclosed method may omit the flattening step if the fibrous substance and segments are advanced through an extruder and flattened as part of the extrusion process. The disclosed method can then proceed to the folding step.

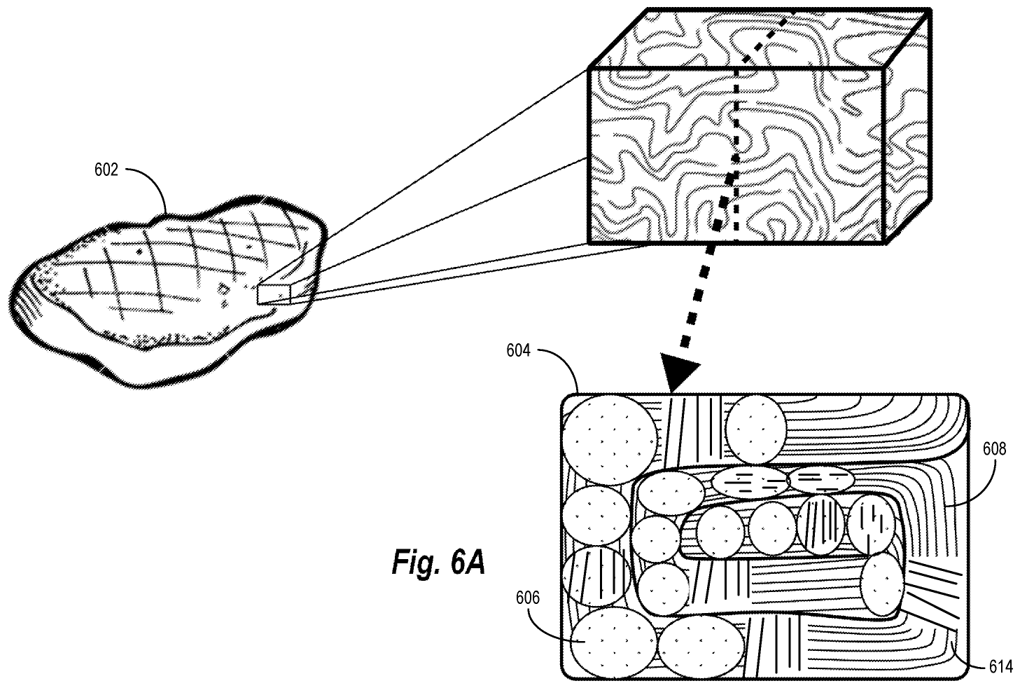

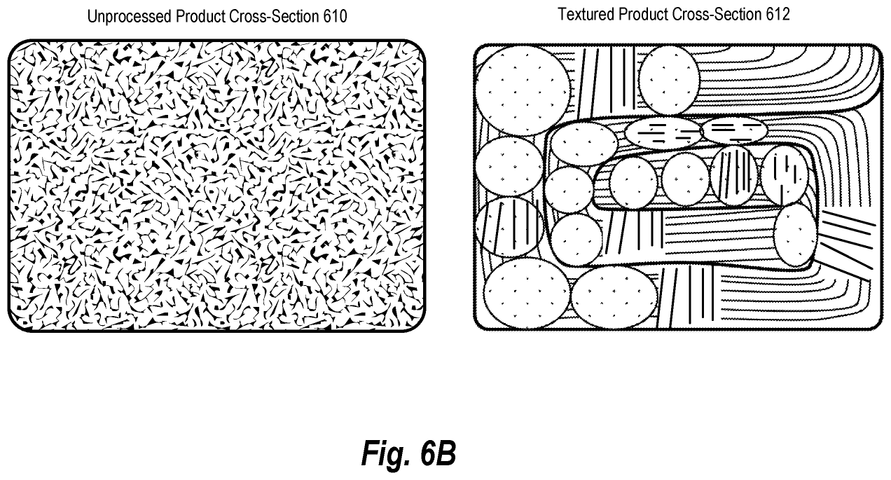

FIGS. 1A-5B and the corresponding paragraphs provide detail regarding steps performed as part of the disclosed method according to one or more embodiments. FIGS. 6A-6B illustrate the fiber structure within a textured product in accordance with one or more embodiments. In particular, FIG. 6A illustrates a diagram representative of the fiber structure within a textured product formed as the result of the disclosed method. FIG. 6B illustrates a diagram representative of the fiber structure within a textured product as opposed to the fiber structure within an untextured product of unprocessed or preprocessed cell-based meat.

FIG. 6A illustrates a textured product 602. As illustrated, the textured product 602 has been portioned and formed into a fillet. The structure of meat fibers within the textured product 602 is further illustrated by a cross-section 604 from a portion extracted from the textured product 602.

As illustrated by the cross-section 604 in FIG. 6A, the textured product 602 has a tertiary structure of aligned fibers resulting from the disclosed method. In particular, the mixing techniques align the meat fibers, and the flattening and folding steps provide a more complex tertiary structure. As illustrated by the cross-section 604, the textured product 602 includes several layers of a grown cell mixture. In each layer, meat fibers are aligned with various directions.

More specifically, as illustrated by FIG. 6A, example fibers 606 align or run along a direction with respect to an x-axis, example fibers 614 align or run along a direction with respect to a y-axis, and example fibers 608 align or run along a direction with respect to a z-axis. The complexity and organization of the meat fibers within the textured product 602 improves the texture of the textured product 602 to mimic that of slaughtered meat.

As mentioned, FIG. 6B illustrates how the disclosed method creates a textured product having a higher ordered structure in addition to fiber alignment relative to unprocessed or raw cell-based-meat products. In particular, FIG. 6B illustrates an unprocessed product cross-section 610 of raw cell-based-meat product. FIG. 6B also illustrates a textured product cross-section 612 illustrating the fiber alignment and higher order structure resulting from the disclosed method.

As illustrated, the fibers within the textured product cross-section 612 have a more ordered structure than the fibers within the unprocessed product cross-section 610. The more ordered structure demonstrated in the textured product cross-section 612 contributes to a texture that is more similar to slaughtered meat, which typically contains substantial parallel alignment between individual muscle fibers.

In particular, slaughtered meat typically comprises fibers having a primary shape of elongated tubes that are stacked or otherwise arranged in a lengthwise fashion. Similarly, the fibers illustrated in the textured product cross-section 612 have a tertiary structure that are aligned on various planes (e.g., x, y, and z-axes). In some embodiments, the folding and flattening techniques of the disclosed method create layers of fibers similar to layers and stacks of fibers found in slaughtered meat. Furthermore, the fibers within the textured product cross-section 612 are aligned in loops and switchbacks that traverse the various planes.

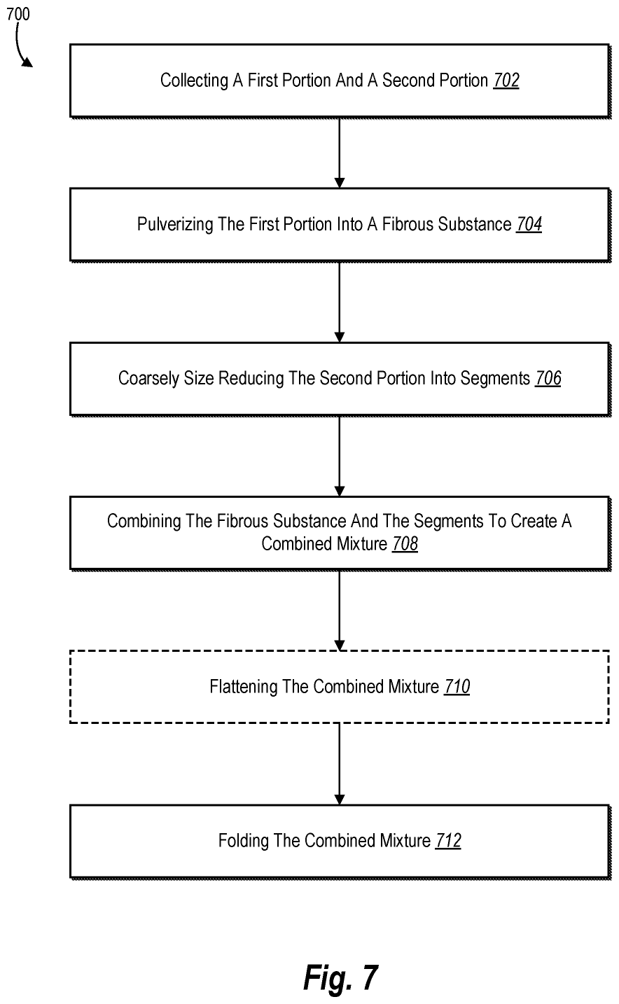

FIGS. 1A-6B, the corresponding text, and the examples provide a number of different methods, techniques, and instruments for performing the disclosed method. In addition to the foregoing, one or more embodiments can also be described in terms of flowcharts comprising acts for accomplishing a particular result. FIG. 7 illustrates such a flowchart of acts. Additionally, the acts described herein may be repeated or performed in parallel with one another or in parallel with different instances of the same or similar acts.

FIG. 7 illustrates a flowchart of a series of acts 700. By way of overview, the series of acts 700 includes an act 702 of collecting a first portion and a second portion, an act 704 of pulverizing the first portion into a fibrous substance, an act 706 of coarsely size reducing the second portion into segments, an act 708 of combining the fibrous substance and the segments to create a combined mixture, an optional act 710 of flattening the combined mixture, and an act 712 of folding the flattened combined mixture.

As illustrated in FIG. 7, the series of acts 700 includes the act 702 of collecting a first portion and a second portion. In particular, the act 702 includes collecting at least a first portion of cell mass and a second portion of cell mass. In some embodiments, collecting at least the first portion of cell mass and the second portion of cell mass comprises: separating a grown cell mass into the first portion of cell mass and the second portion of cell mass; or collecting one or more first grown cell masses as the first portion of cell mass and one or more second grown cell masses as the second portion of cell mass. In some embodiments, the first portion of cell mass comprises a first cell type and the second portion of cell mass comprises a second cell type.

The series of acts 700 illustrated in FIG. 7 includes the act 704 of pulverizing the first portion into a fibrous substance. In particular, the act 704 comprises pulverizing the first portion of cell mass into a fibrous substance. In the alternative or as part of pulverizing, the act 704 can comprise cutting the first portion of cell mass into fine pieces. In some embodiments, pulverizing the first portion into the fibrous substance comprises finely chopping the first portion of cell mass into a fibrous pulp or a fibrous paste.

As further illustrated in FIG. 7, the series of acts 700 includes the act 706 of coarsely size reducing the second portion into segments. In particular, the act 706 comprises coarsely size reducing the second portion of cell mass into segments. In the alternative or as part of coarsely size reducing the second portion of cell mass, the act 706 can comprise size reducing the second portion of cell mass into small segments that exceed a size of the fine pieces from the first portion. In some embodiments, coarsely size reducing the second portion comprises cutting the second portion into pieces having a threshold length. Additionally, in some embodiments, the first portion of cell mass is one quarter to one half of a grown cell mass, and the second portion of cell mass is one half to three-quarters of the grown cell mass. In one or more examples, size reducing the second portion of cell mass into small segments comprises tearing the second portion of cell mass into irregular sized small segments. In some examples, size reducing the second portion into small segments comprises cutting the second portion into rectangular cuboids having an approximate length, width, and height.

The series of acts 700 illustrated in FIG. 7 includes the act 708 of combining the fibrous substance and the segments to create a combined mixture. In particular, the act 708 includes combining the fibrous substance and the segments to create a combined mixture. In some embodiments, the act 708 further comprises utilizing an instrument to align meat fibers in the fibrous substance and the segments. In some embodiments, aligning the meat fibers comprises pushing or pulling tines through the fibrous substance and the segments. Additionally, or alternatively, in some examples, aligning the meat fibers comprises advancing the fibrous substance and the segments through an extruder.

In the alternative or as part of combining the fibrous substance and the segments to create a combined mixture, in one or more embodiments, the act 708 comprises combining the fine pieces and the small segments to create a combined mixture. In some embodiments, combining the fine pieces and the small segments comprises utilizing tines or an extruder to align meat fibers in the fine pieces and the small segments. Additionally, in one example, combining the fine pieces and the small segments to create the combined mixture comprises: mixing the fine pieces with each other, mixing the small segments with each other, and combining the fine pieces and the small segments. In one or more embodiments, combining the fine pieces and the small segments to create the combined mixture further comprises further mixing the combined fine pieces and small segments.

FIG. 7 further illustrates the optional act 710 as part of the series of acts 700 of flattening the combined mixture.

The series of acts 700 further includes the act 712 of folding the combined mixture. In particular, the act 712 comprises folding the combined mixture to form a textured product. In one or more embodiments, folding the combined mixture comprises folding the combined mixture over itself in thirds. In some embodiments, folding the combined mixture comprises folding the flattened combined mixture.

Furthermore, in one or more embodiments, the series of acts 700 further comprises an additional act of performing a plurality of cycles of flattening the combined mixture and folding the flattened combined mixture.

In some embodiments, the series of acts 700 also comprises an additional step of portioning the combined mixture into final product weights before flattening the combined mixture.

As described, the disclosed method can comprise various steps to create a textured product. In some embodiments, regardless of the method for creating or preparing a textured product, the textured cell-based-meat product can comprise: a first layer of a grown cell mixture having meat fibers aligned with a first direction; a second layer of the grown cell mixture having meat fibers aligned with a second direction, wherein the second layer of the grown cell mixture is positioned underneath the first layer of the grown cell mixture; and a third layer of a grown cell mixture having meat fibers aligned with a third direction, wherein the third layer of the grown cell mixture is positioned underneath the first layer of the grown cell mixture.

In some embodiments, the grown cell mixture comprises: a first portion of a grown cell mass cut into fine pieces; and a second portion of the grown cell mass reduced into small segments that exceed a size of the fine pieces. Additionally, in some embodiments, the grown cell mixture comprises a first portion of a grown cell mass cut into a fibrous paste or a fibrous pulp; and a second portion of the grown cell mass reduced into rectangular segments having a threshold length. Furthermore, in one or more embodiments, the first direction comprises a direction with respect to an X axis, the second direction comprises a different direction with respect to a Y axis, and the third direction comprises yet another direction with respect to a Z axis.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

The present invention may be embodied in other specific forms without departing from its spirit or essential characteristics. Indeed, the described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method for preparing a textured grown cell mass, the method comprising:
collecting at least a first portion of cell mass and a second portion of cell mass;
pulverizing the first portion of cell mass into a fibrous substance;
coarsely size reducing the second portion of cell mass into segments;
combining the fibrous substance and the segments to create a combined mixture; and
folding the combined mixture to form a textured product.

2. The method of claim 1, wherein collecting at least the first portion of cell mass and the second portion of cell mass comprises:
separating a grown cell mass into the first portion of cell mass and the second portion of cell mass; or
collecting one or more first grown cell masses as the first portion of cell mass and one or more second grown cell masses as the second portion of cell mass.

3. The method of claim 1, wherein the first portion of cell mass comprises a first cell type and the second portion of cell mass comprises a second cell type.

4. The method of claim 1, wherein combining the fibrous substance and the segments comprises aligning meat fibers in the fibrous substance and the segments.

5. The method of claim 1, wherein combining the fibrous substance and the segments comprises utilizing an instrument to align meat fibers in the fibrous substance and the segments.

6. The method of claim 5, wherein aligning the meat fibers comprises:
pushing or pulling tines through the fibrous substance and the segments; or
advancing the fibrous substance and the segments through an extruder.

7. The method of claim 1, wherein pulverizing the first portion of cell mass into the fibrous substance comprises finely chopping the first portion of cell mass into a fibrous pulp or a fibrous paste.

8. The method of claim 1, wherein coarsely size reducing the second portion of cell mass comprises cutting the second portion of cell mass into pieces having a threshold length.

9. The method of claim 1, further comprising performing a plurality of cycles of flattening the combined mixture and folding the combined mixture.

10. The method of claim 1, wherein:
the first portion of cell mass is one quarter to one half of a grown cell mass; and
the second portion of cell mass is one half to three-quarters of the grown cell mass.

11. A method for preparing a textured grown cell mass, the method comprising:
collecting at least a first portion of cell mass and a second portion of cell mass;
cutting the first portion of cell mass into fine pieces;
size reducing the second portion of cell mass into small segments that exceed a size of the fine pieces from the first portion;
combining the fine pieces and the small segments to create a combined mixture; and
folding the combined mixture to form a textured product.

12. The method of claim 11, wherein the method further comprises:
flattening the combined mixture; and
wherein folding the combined mixture comprises folding the flattened combined mixture.

13. The method of claim 11, wherein combining the fine pieces and the small segments comprises utilizing tines or an extruder to align meat fibers in the fine pieces and the small segments.

14. The method of claim 13, wherein combining the fine pieces and the small segments to create the combined mixture comprises:
mixing the fine pieces with each other;
mixing the small segments with each other; and
combining the fine pieces and the small segments.

15. The method of claim 11, wherein size reducing the second portion of cell mass into small segments comprises tearing the second portion of cell mass into irregular sized small segments.

16. The method of claim 11, wherein size reducing the second portion of cell mass into small segments comprises cutting the second portion of cell mass into rectangular cuboids having an approximate length, width, and height.

17. A textured cell-based-meat product comprising:
a first layer of a grown cell mixture having meat fibers aligned with a first direction;
a second layer of the grown cell mixture having meat fibers aligned with a second direction, wherein the second layer of the grown cell mixture is positioned underneath the first layer of the grown cell mixture; and
a third layer of a grown cell mixture having meat fibers aligned with a third direction, wherein the third layer of the grown cell mixture is positioned underneath the first layer of the grown cell mixture.

18. The textured cell-based-meat product of claim 17, wherein the grown cell mixture comprises:
a first portion of cell mass cut into fine pieces; and
a second portion of cell mass reduced into small segments that exceed a size of the fine pieces.

19. The textured cell-based-meat product of claim 17, wherein the grown cell mixture comprises:
a first portion of cell mass cut into a fibrous paste or a fibrous pulp; and
a second portion of cell mass reduced into rectangular segments having a threshold length.

20. The textured cell-based-meat product of claim 17, wherein the first direction comprises a direction with respect to an X axis, the second direction comprises a different direction with respect to a Y axis, and the third direction comprises yet another direction with respect to a Z axis.
